(19) United States
(12) Patent Application Publication
(10) Pub. No.: US 2006/0181643 A1
(43) Pub. Date: Aug. 17, 2006

(54) Spatial image conversion

(76) Inventor: Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/552,053

(22) PCT Filed: Mar. 31, 2004
(86) PCT No.: PCT/IB04/50371

§ 371 Date: Oct. 4, 2005

(30) Foreign Application Priority Data
Apr. 10, 2003 (EP) 03100977.2

(51) Int. Cl. H04N 7/01

(52) U.S. Cl. 348/458

(57) ABSTRACT

The invention relates to an image conversion unit (100) for converting an input image with a first resolution into an output image with a second resolution being higher than the first resolution the image conversion unit (100) comprises: a coefficient-determining means (108) for determining a first filter coefficient on basis of pixel values of the input image; and an adaptive filtering means (106) for computing a second pixel value of an intermediate image on basis of a first one of the pixel values of the input image and the first filter coefficient; and a low-pass filter the intermediate image resulting in the output image.

The invention relates to an image conversion unit for converting a first image with a first resolution into a second image with a second resolution being higher than the first resolution, the image conversion unit comprising:

a coefficient-determining means for determining a first filter coefficient on basis of pixel values of the first image; and

an adaptive filtering means for computing a second pixel value of the second image on basis of a first one of the pixel values of the first image and the first filter coefficient

The invention further relates to an image processing apparatus, comprising:

receiving means for receiving a signal corresponding to a first image; and

an image conversion unit for converting the first image into a second image, as described above.

The invention further relates to a method of converting a first image with a first resolution into a second image with a second resolution being higher than the first resolution, the method comprising:

determining a first filter coefficient on basis of pixel values of the first image; and

computing a second pixel value of the second image on basis of a first one of the pixel values of the first image and the first filter coefficient.

The invention further relates to a computer program product to be loaded by a computer arrangement, comprising instructions to convert a first image with a first resolution into a second image with a second resolution being higher than the first resolution.

The advent of HDTV emphasizes the need for spatial up-conversion techniques that enable standard definition (SD) video material to be viewed on high definition (HD) television (TV) displays. Conventional techniques are linear interpolation methods such as bi-linear interpolation and methods using poly-phase low-pass interpolation filters. The former is not popular in television applications because of its low quality, but the latter is available in commercially available ICs. With the linear methods, the number of pixels in the frame is increased, but the perceived sharpness of the image is not increased. In other words, the capability of the display is not fully exploited.

Additional to the conventional linear techniques, a number of non-linear algorithms have been proposed to achieve this up-conversion. Sometimes these techniques are referred to as content-based or edge dependent spatial up-conversion. A number of these up-conversion techniques have been described in an overview article “Towards an overview of spatial up-conversion techniques”, by Meng Zhao et al., in the proceedings of the ISCE 2002, Erfurt, Germany, 23-26 Sep. 2002.

The better techniques are non-linear, as this is the only way to produce information in the additionally available spectrum. Since this additional information has never been registered by a camera, but estimated, applying assumptions about natural images, it is not inherently consistent over time. Indeed, artifacts occur that appear as “edge-business”.

It is an object of the invention to provide an image conversion unit of the kind described in the opening paragraph, which is arranged to provide images with an improved perceived result

This object of the invention is achieved in that the image conversion unit further comprises a low-pass filter for filtering the second image. By low-pass filtering noise reduction and time-consistency is achieved. Preferably the low-pass filtering is focused on that part of the spatial spectrum that has been introduced by the non-linear spatial up-conversion. Note that in current image processing architectures, noise reduction, if available, is performed prior to spatial up-conversion. A reason for that is that performing low-pass filtering after spatial up-conversion is relatively expensive because of storage requirements of intermediate results. Another reason is that the amount of computations is relatively high.

The low-pass filter is a temporal filter, a spatial filter or a spatio-temporal filter.

An embodiment of the image conversion unit according to the invention comprises a feature extraction unit for extracting features from the first image or the second image. This feature extraction unit is arranged to control the low-pass filter. Preferably, the feature extraction unit is arranged to extract features from the first image. An advantage of applying the first image, being the original image which is not up-converted, instead of the second image to control the low-pass filtering of the second image, is that the control is not disturbed by artifacts caused by the up-conversion.

In an embodiment of the image conversion unit according to the invention, the feature extraction unit is an edge detector unit for detecting edges in the first image. Preferably this embodiment comprises an edge-adaptive low-pass filter, which is designed to filter the second image along the edges. Alternatively, a K-nearest or sigma-nearest spatial filter is applied. Alternatively, the feature extraction unit is an edge detector unit for detecting edges in the second image.

In another embodiment of the image conversion unit according to the invention, the feature extraction unit is a motion detector unit for computing a value representing the amount of motion in the first image, relative to a third image of a series of images to which both the first image and the third image belong. Preferably this embodiment according to the invention comprises a recursive temporal low-pass filter. In that case the value representing the amount of motion is applied to control the mixing ratio between the second image and the previously filtered image. A recursive temporal low-pass filter is relatively cheap and robust. Alternatively, the feature extraction unit is a motion detector unit for computing a value representing the amount of motion in the second image, relative to a fourth image of a further series of images to which both the second image and the fourth image belong.

In another embodiment of the image conversion unit according to the invention, the feature extraction unit is a motion estimation unit for computing motion vectors for respective groups of pixels of the first image, relative to further groups of pixels of a third image of a series of images to which both the first image and the third image belong. Preferably this embodiment according to the invention comprises a recursive temporal low-pass filter comprising a motion compensation unit for motion compensation of a previously filtered image. An advantage of applying motion compensation is that even in the case of motion the image conversion unit provides high quality output images. Alternatively, the feature extraction unit is a motion estimation unit for computing motion vectors for respective groups of pixels of the second image, relative to further groups of pixels of a fourth image of a further series of images to which both the second image and the fourth image belong.

An embodiment of the image conversion unit according to the invention is arranged to selectively provide components in a predetermined spatial frequency range of the second image, to the temporal filter, the predetermined frequency range corresponding to frequencies, which are above the Nyquist frequency of the first image. In this embodiment according to the invention the low-pass filtering is focused on that part of the spatial spectrum that has been introduced by the non-linear spatial up-conversion. Other parts of the spatial spectrum substantially remain unchanged.

An embodiment of the image conversion unit according to the invention comprises a band-split unit connected to the adaptive filtering means and being arranged to provide the components to the temporal filter. Alternatively, the image conversion unit is designed to subtract a linearly up-converted image derived from the first image from the content-adaptively up-converted second image and is arranged to perform low-pass filtering on the intermediate subtraction image followed by addition to the linearly up-converted image.

It is a further object of the invention to provide an image processing apparatus of the kind described in the opening paragraph, which is arranged to provide images with an improved perceived result.

This object of the invention is achieved in that the image conversion unit further comprises a low-pass filter for filtering the second image. The image processing apparatus optionally comprises a display device for displaying the filtered image. The image processing apparatus might e.g. be a TV, a set top box, a satellite tuner, a VCR (Video Cassette Recorder) player or a DVD (Digital Versatile Disk) player.

It is a further object of the invention to provide a method of the kind described in the opening paragraph, which provides images with an improved perceived result.

This object of the invention is achieved in that the method further comprises low-pass filtering of the second image.

It is a further object of the invention to provide a computer program product of the kind described in the opening paragraph, which provides images with an improved perceived result.

This object of the invention is achieved in that the computer program product, after being loaded, provides processing means with the capability to carry out:

determining a first filter coefficient on basis of pixel values of the first image;

computing a second pixel value of the second image on basis of a first one of the pixel values of the first image and the first filter coefficient; and

low-pass filtering of the second image. Modifications of the image conversion unit and variations thereof may correspond to modifications and variations thereof of the image processing apparatus, the method and the computer program product described.

These and other aspects of the image conversion unit, of the image processing apparatus, of the method and of the computer program product according to the invention will become apparent from and will be elucidated with respect to the implementations and embodiments described hereinafter and with reference to the accompanying drawings, wherein:

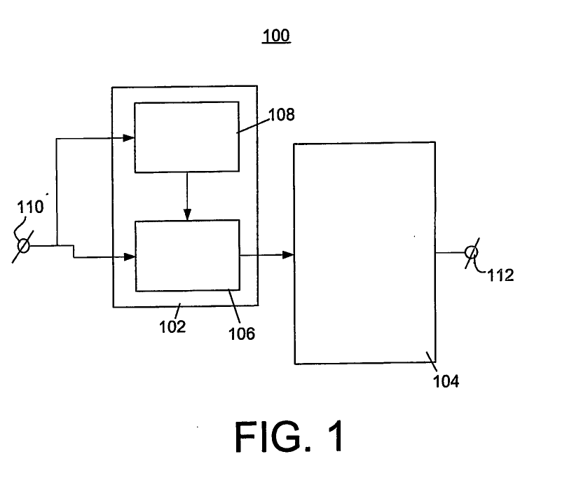

FIG. 1 schematically shows an embodiment of the image conversion unit according to the invention;

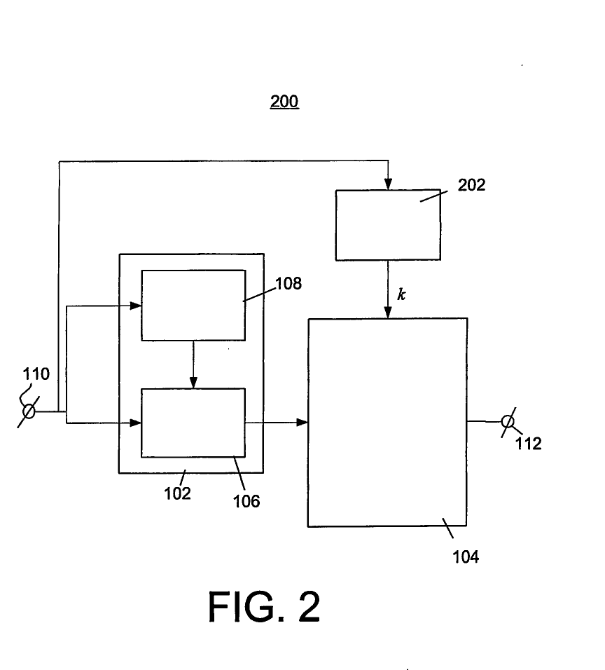

FIG. 2 schematically shows an embodiment of the image conversion unit according to the invention, comprising a feature extraction unit for controlling the low-pass filter,

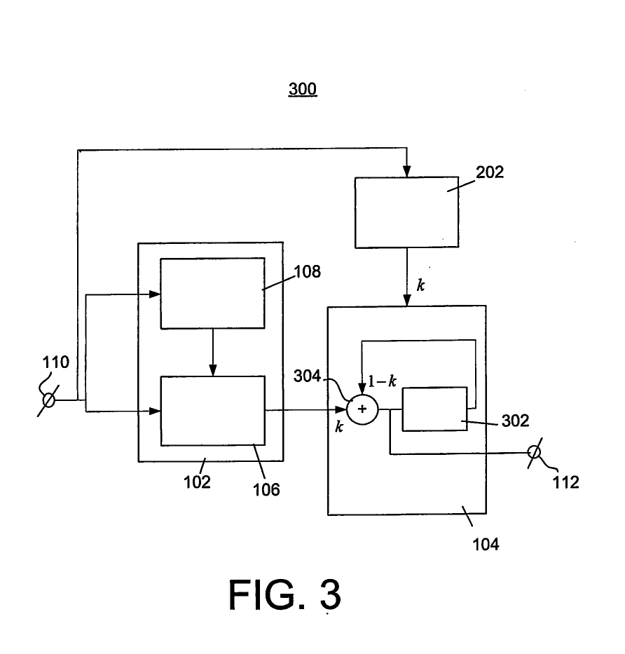

FIG. 3 schematically shows an embodiment of the image conversion unit according to the invention, comprising a first order temporally-recursive filter;

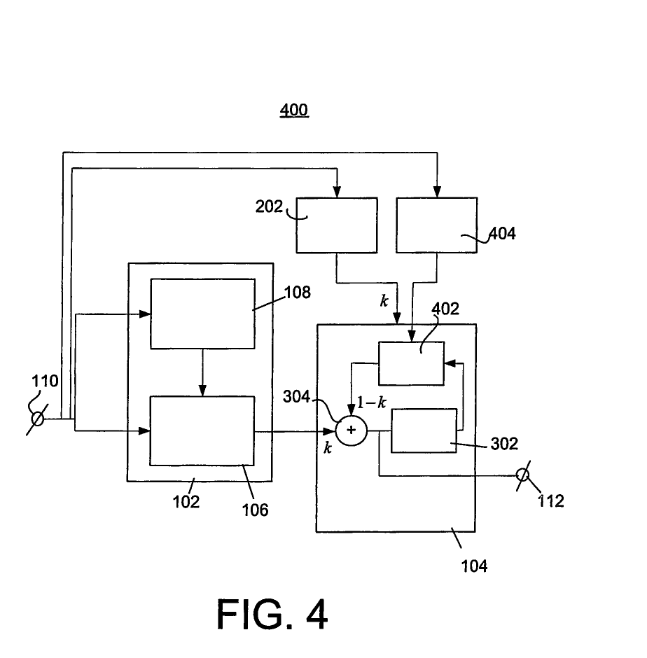

FIG. 4 schematically shows an embodiment of the image conversion unit according to the invention, comprising a first order temporally-recursive filter including motion compensation of the previously filtered image;

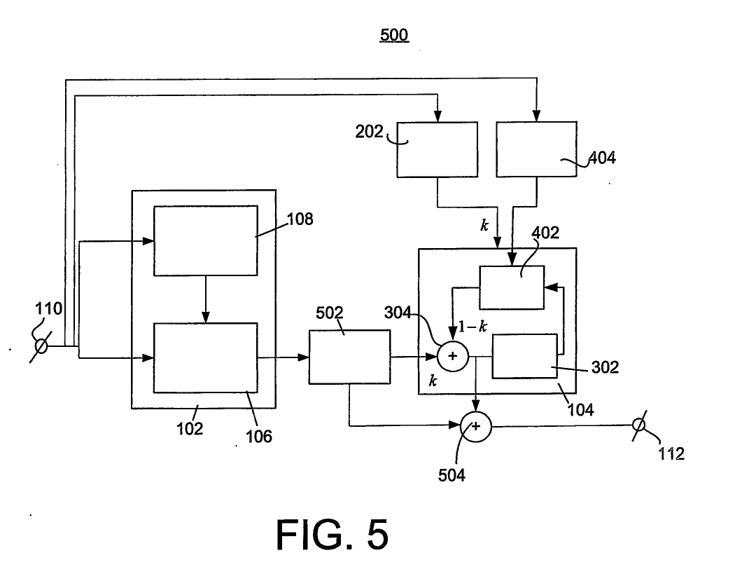

FIG. 5 schematically shows an embodiment of the image conversion unit according to the invention, comprising a band-split unit connected to the adaptive filtering means and being arranged to provide components of the second image in a predetermined spatial frequency range, to the low-pass filter;

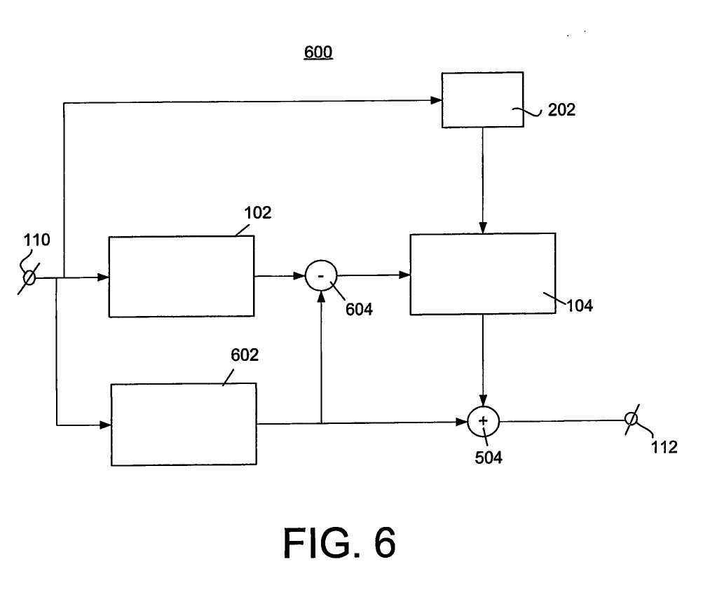

FIG. 6 schematically shows an embodiment of the image conversion unit according to the invention, comprising both a linear conversion unit and a non-linear conversion unit; and

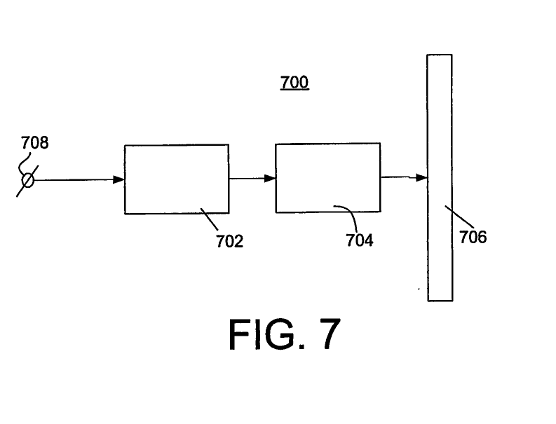

FIG. 7 schematically shows an embodiment of the image processing apparatus according to the invention.

Same reference numerals are used to denote similar parts throughout the figures.

FIG. 1 schematically shows an embodiment of the image conversion unit 100 according to the invention. The image conversion unit 100 is arranged to convert an input image with a first resolution into an output image with a second resolution being higher than the first resolution. Typically the input image is part of a input sequence video of SD (standard definition) images, which is provided at the input connector 110 of the image conversion unit 100 and the second image is part of a sequence of output HD (high definition) images. The image conversion unit 100 provides the sequence of output HD images at the output connector 112. The image conversion unit comprises:

A content adaptive up-conversion unit 102 which converts an input image into an intermediate image having a higher resolution than the input image; and

A low-pass filter 104 for filtering the intermediate image resulting into an output image.

The content adaptive up-conversion unit 102 comprises:

A coefficient-determining unit 108 for determining filter coefficients on basis of pixel values of the input image; and

An adaptive filtering unit 106 for computing pixel values of the intermediate image on basis of pixel values of the input image and the filter coefficients derived from the input image.

The content adaptive up-conversion unit 102 is based on one of the up-conversion algorithms described in the article “Towards an overview of spatial up-conversion techniques”, by Meng Zhao et al., in the proceedings of the ISCE 2002, Erfurt, Germany, 23-26 Sep. 2002.

The filter coefficient-determining unit 108, the adaptive filtering unit 106 and the low-pass filter 104 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

FIG. 2 schematically shows an embodiment of the image conversion unit 200 according to the invention, comprising a feature extraction unit 202 for controlling the low-pass filter 104. The feature extraction unit 202 might be an edge detector unit for detecting edges in the input image. In that case the low-pass filter might perform a edge adaptive filtering as explained in the article “Edge adaptive filtering: how much and which direction?”, by R. Jha and M. E. Jernigan, in the proceedings of IEEE International Conference on Man and Cybernetics, 1989, 14-17 November page 364-366 vol. 1. Alternatively the feature extraction unit 202 is arranged to compute a value representing the amount of motion in the input image, relative to another input image. Preferably also the direction of the motion is estimated. In that case the feature extraction unit 202 is a motion estimation unit for computing motion vectors for respective groups of pixels of the input image, relative to further groups of pixels of the other input image. The motion estimator is e.g. as specified in the article “True-Motion Estimation with 3-D Recursive Search Block Matching” by G. de Haan et. al. in IEEE Transactions on circuits and systems for video technology, vol. 3, no. 5, October 1993, pages 368-379. The low pass-filtering might be based on the algorithm disclosed in the article “Noise reduction in image sequences using motion compensated temporal filtering”, by E. Dubois and S. Sabri, in IEEE, Transactions on Communication, no. 7, 1984, pp. 826-831.

FIG. 3 schematically shows an embodiment of the image conversion unit 300 according to the invention, comprising a first order temporally-recursive filter 104. The first order temporally-recursive filter 104 comprises a memory device 302 for temporarily storage of a recently filtered image. The filtered image is mixed with an intermediate image provided by the content adaptive up-conversion unit 102. The mixing is performed by means of the mixing unit 304 which is controlled on basis of a parameter k which has been derived from one or more input images by means of the feature extraction unit 202. The output of the first order temporally-recursive filter 104 is given by equation 1:
F_{F}(\vec{x},n)=kF(\vec{x},n)+(1−k)F_{F}(\vec{x},n−1), (1)
with pixel position \vec{x}, input luminance value F(\vec{x}, n) and output luminance value F_{F}(\vec{x}, n).

FIG. 4 schematically shows an embodiment of the image conversion unit 400 according to the invention, comprising a first order temporally-recursive filter 104 including motion compensation of the previously filtered image. This embodiment according to the invention comprises a motion estimation unit 404 and a motion compensation unit 402, which is provided with motion vectors being estimated by the motion estimation unit 404. The previously filtered image is motion compensated relative to the recently filtered image before mixing by means of the mixing unit 304 is performed. Alternatively the recently filtered image is motion compensated relative to the previously filtered image before mixing by means of the mixing unit 304 is performed. (Not depicted). The parameter k, which is used to control the mixing ratio, might be computed by means of a separate feature extraction unit 202. However, preferably this parameter k is based on the estimated motion vectors and is also computed by means of the motion estimation unit 404. That means that the feature extraction unit 202 is optional or part of the motion estimation unit 404.

FIG. 5 schematically shows an embodiment of the image conversion unit 500 according to the invention, comprising a band split unit 502 connected to the adaptive filtering unit 106 and being arranged to provide components of the second image in a redetermined spatial frequency range, to the low-pass filter 104. The predetermined spatial frequency range substantially corresponds to frequencies, which are above the Nyquist frequency of the input image. In this embodiment according to the invention the temporal low-pass filtering is focused on that part of the spatial frequency spectrum that has been introduced by the non-linear spatial up-conversion. The other part of the spatial frequency spectrum is provided to the adding unit 504, by the band split unit 502, to which also the temporarily low-passed image data is provided. The working of this image conversion unit 500 is explained below. An input image is up-converted to an intermediate image by means of the content adaptive up-conversion unit 102. The frequency components of the intermediate image are split by means of the band-split unit 502 into first spatial frequency components, which are below the Nyquist frequency of the input image, and second frequency components, which are above the Nyquist frequency of the input image. The second frequency components are provided to the temporally recursive filter 104. The output of the temporally recursive filter 104 is mixed with the first spatial frequency components by means of the adding unit 504.

FIG. 6 schematically shows an embodiment of the image conversion unit 600 according to the invention, comprising both a linear conversion unit 602 and a non-linear conversion unit 102. In this embodiment according to the invention, the low-pass filtering is focused on that part of the spatial frequency spectrum that has been introduced by the non-linear spatial up-conversion. Other parts of the spatial frequency spectrum substantially remain unchanged. The image conversion unit 600 comprises:

A content adaptive up-conversion unit 102 which converts an input image having a first resolution into a first intermediate image having a second resolution which is higher than the first resolution;

A linear up-conversion unit 602 which converts the input image into a second intermediate image having the second resolution;

A subtraction unit 604 for subtracting the second intermediate image from the first intermediate image;

A low-pass filter 104 for filtering the subtraction image;

A combining unit 504 for combining the filtered subtraction image with the second intermediate image. Preferably the image conversion unit 600 further comprises a feature extraction unit 202 for controlling the low-pass filter 104 as explained in connection with any of the FIGS. 1-5. The working of the image conversion unit 600 is as follows. The second intermediate image, i.e. the linearly up-converted image comprises frequency components in the range below the Nyquist frequency of the input image. However, the first intermediate image, i.e. the non-linearly up-converted image also comprises frequency components in the range above the Nyquist frequency of the input image. By subtracting the second intermediate image from the first intermediate image the frequency components in the range above the Nyquist frequency of the input image are selected. The subtraction image, i.e. an image with relatively high spatial frequencies is subsequently low-pass filtered by means of a temporal filter, preferably a motion compensated first order temporarily recursive filter. Finally the filtered subtraction image is combined with the second intermediate image, i.e. the linearly up-converted image.

FIG. 7 schematically shows an embodiment of the image processing apparatus 700 according to the invention, comprising:

Receiving means 702 for receiving a signal representing SD images.

The image conversion unit 704 as described in connection with any of the FIGS. 1-6; and

A display device 706 for displaying the HD output images of the image conversion unit 704. This display device 706 is optional.

The signal may be a broadcast signal received via an antenna or cable but may also be a signal from a storage device like a VCR (Video Cassette Recorder) or Digital Versatile Disk (DVD). The signal is provided at the input connector 708. The image processing apparatus 700 might e.g. be a TV. Alternatively the image processing apparatus 700 does not comprise the optional display device but provides HD images to an apparatus that does comprise a 25 display device 706. Then the image processing apparatus 700 might be e.g. a set top box, a satellite-tuner, a VCR player or a DVD player. But it might also be a system being applied by a film-studio or broadcaster.

It should be noted that the above-mentioned embodiments illustrate rather than limit the invention and that those skilled in the art will be able to design alternative 30 embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. An image conversion unit (100,200,300,400,500,600) for converting a first image with a first resolution into a second image with a second resolution being higher than the first resolution, the image conversion unit (100,200,300,400,500,600) comprising:
a coefficient-determining means (108) for determining a first filter coefficient on basis of pixel values of the first image; and
an adaptive filtering means (106) for computing a second pixel value of the second image on basis of a first one of the pixel values of the first image and the first filter coefficient, characterized in that the image conversion unit (100,200,300,400,500,600) further comprises a low-pass filter (104) for filtering the second image.

2. An image conversion unit (200,300,400,500,600) as claimed in claim 1, characterized in that the image conversion unit (100,200,300,400,500,600) comprises a feature extraction unit (202) for extracting features from the first image or the second image and that the feature extraction unit (202) is arranged to control the low-pass filter (104).

3. An image conversion unit (200,300,400,500,600) as claimed in claim 2, characterized in that the feature extraction unit (202) is an edge detector unit for detecting edges in the first image.

4. An image conversion unit (200,300,400,500,600) as claimed in claim 2, characterized in that the feature extraction unit (202) is a motion detector unit for computing a value representing the amount of motion in the first image, relative to a third image of a series of images to which both the first image and the third image belong.

5. An image conversion unit (200,300,400,500,600) as claimed in claim 2, characterized in that the feature extraction unit (202) is a motion estimation unit for computing motion vectors for respective groups of pixels of the first image, relative to further groups of pixels of a third image of a series of images to which both the first image and the third image belong.

6. An image conversion unit (100,200,300,400,500,600) as claimed in claim 1, characterized in that the low-pass filter (104) is a temporal filter.

7. An image conversion unit (400,500) as claimed in claim 6, characterized in that the low-pass filter (104) is a temporal recursive filter comprising a motion compensation unit (402) for motion compensation of a previously filtered image.

8. An image conversion unit (500,600) as claimed in claim 6, characterized in being arranged to selectively provide components in a predetermined spatial frequency range of the second image, to the temporal filter, the predetermined frequency range corresponding to frequencies which are above the Nyquist frequency of the first image.

9. An image conversion unit (500) as claimed in claim 8, characterized in comprising a band-split unit connected to the adaptive filtering means and being arranged to provide the components to the temporal filter.

10. An image conversion unit (100,200) as claimed in claim 3, characterized in that the low-pass filter (104) is an edge-adaptive spatial low-pass filter.

11. An image processing apparatus (700), comprising:
receiving means for receiving a signal corresponding to a first image; and
an image conversion unit (100,200,300,400,500,600) for converting the first image into a second image, the image conversion unit (100,200,300,400,500,600) as claimed in claim 1.

12. An image processing apparatus (700) as claimed in claim 11, characterized in further comprising a display device (706) for displaying the low-pass filtered second image.

13. An image processing apparatus (700) as claimed in claim 11, characterized in that it is a TV.

14. A method of converting a first image with a first resolution into a second image with a second resolution being higher than the first resolution, the method comprising:
determining a first filter coefficient on basis of pixel values of the first image; and
computing a second pixel value of the second image on basis of a first one of the pixel values of the first image and the first filter coefficient, characterized in comprising low-pass filtering of the second image.

15. A computer program product to be loaded by a computer arrangement, comprising instructions to convert a first image with a first resolution into a second image with a second resolution being higher than the first resolution, the computer arrangement comprising processing means and a memory, the computer program product, after being loaded, providing said processing means with the capability to carry out:
determining a first filter coefficient on basis of pixel values of the first image;
computing a second pixel value of the second image on basis of a first one of the pixel values of the first image and the first filter coefficient; and
low-pass filtering of the second image.
